(19) United States
(12) Patent Application Publication
(10) Pub. No.: US 2013/0298221 A1
(43) Pub. Date: Nov. 7, 2013

(54) FIREWALLS FOR FILTERING COMMUNICATIONS IN A DYNAMIC COMPUTER NETWORK

(71) Applicants: Wayne B. Smith, Melbourne Beach, FL (US); Ryan E. Sharpe, Indialantic, FL (US)

(72) Inventors: Wayne B. Smith, Melbourne Beach, FL (US); Ryan E. Sharpe, Indialantic, FL (US)

(73) Assignee: HARRIS CORPORATION, Melbourne, FL (US)

(21) Appl. No.: 13/461,158

(22) Filed: May 1, 2012

(51) Int. Cl. G06F 21/00

(52) U.S. Cl. 726/13; 726/11

(57) ABSTRACT

A method and apparatus for filtering data communications in a dynamic computer network is disclosed. The method includes receiving a data packet that includes a plurality of identity parameters. The data packet is filtered by comparing the plurality of identity parameters to a set of filtering rules. The filtering rules allow the data packet into the network if a set of said identity parameters have been pseudorandomly transformed to specify false identity parameters and those false identity parameters are within a set of currently allowed false identity parameters determined based on a mission plan.

### BACKGROUND OF THE INVENTION

1. Statement of the Technical Field

The inventive arrangements relate to computer network security, and more particularly to systems for filtering communications entering a network where the network is dynamically maneuverable to defend against malicious attacks.

2. Description of the Related Art

The central weakness of current cyber infrastructure is its static nature. Assets receive permanent or infrequently-changing identifications, allowing adversaries nearly unlimited time to probe networks, map and exploit vulnerabilities. Additionally, data traveling between these fixed entities can be captured and attributed. The current approach to cyber security places technologies such as firewalls and intrusion detection systems around fixed assets, and uses encryption to protect data en route. However, this traditional approach is fundamentally flawed because it provides a fixed target for attackers. In today's globally connected communications infrastructure, static networks are vulnerable networks.

The Defense Advanced Research Projects Agency (DARPA) Information Assurance (IA) Program has performed initial research in the area of dynamic network defense. A technique was developed under the Information Assurance Program to dynamically reassign Internet protocol (IP) address space feeding into a pre-designated network enclave for the purpose of confusing any would-be adversaries observing the network. This technique is called dynamic network address transformation (DYNAT). An overview of the DYNAT technology was presented in a published paper by DARPA entitled Dynamic Approaches to Thwart Adversary Intelligence (2001).

### SUMMARY OF THE INVENTION

Embodiments of the invention concern a method of filtering data communications in a dynamic computer network. The method includes receiving a data packet that includes a plurality of identity parameters. The data packet is filtered by comparing the plurality of identity parameters to a set of filtering rules. The filtering rules allow the data packet into the network if a set of said identity parameters have been pseudorandomly transformed to specify false identity parameters and those false identity parameters are within a set of currently allowed false identity parameters determined based on a mission plan.

The invention also concerns a network device that includes input circuitry connected to an input port that is configured to receive a data packet. The data packet includes a plurality of identity parameters. The network device also includes a computer-readable storage medium, having stored thereon a computer program for filtering data communications in a dynamic network, the computer program having a plurality of code sections, the code sections executable by a network device to cause the network device to perform a series of steps. The steps include filtering the data packet by comparing the plurality of identity parameters to a set of filtering rules. The filtering rules allow the data packet into the network if a set of said identity parameters have been pseudorandomly transformed to specify false identity parameters that are within a set of currently allowed false identity parameters determined based on a mission plan.

### BRIEF DESCRIPTION OF THE DRAWINGS

Embodiments will be described with reference to the following drawing figures, in which like numerals represent like items throughout the figures, and in which:

FIG. 1 is an example of a computer network that is useful for understanding the present invention.

FIG. 2 is an example of a module that can be used in the present invention for performing certain manipulations of identity parameters.

FIG. 3 is a drawing that is useful for understanding a tool that can be used to help characterize the network in FIG. 1.

FIG. 4, is an example of a dialog box of a graphical user interface that can be used to select dynamic settings for modules in FIG. 1.

FIG. 5 is an example of a dialog box of a graphical user interface that can be used to select a sequence of active states and bypass states associated with each module in FIG. 1.

FIG. 6 is a diagram that is useful for understanding the way in which a mission plan can be communicated to a plurality of modules in the network in FIG. 1.

FIG. 7 is an example of a dialog box of a graphical user interface that can be used to select a mission plan and communicate the mission plan to the modules as shown in FIG. 6.

FIG. 8 is a flowchart that is useful for understanding the operation of a module in FIG. 1.

FIG. 9 is a flowchart that is useful for understanding the operation of a network control software application (NCSA) in relation to creating and loading mission plans.

FIG. 10 is a block diagram of a computer architecture that can be used to implement the modules in FIG. 1.

FIG. 11 is a block diagram of a computer architecture that can be used to implement the network administration computer (NAC) in FIG. 1.

FIG. 12 is a flowchart that is useful for understanding the operation of a firewall.

FIG. 13 is a table that is useful for understanding some of the types of identity parameters that can be modified.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The invention is not limited by the illustrated ordering of acts or events, as some acts may occur in different orders and/or concurrently with other acts or events. Furthermore, not all illustrated acts or events are required to implement a methodology in accordance with the invention.

It should also be appreciated that the terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Further, unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

### Identity Agile Computer Network

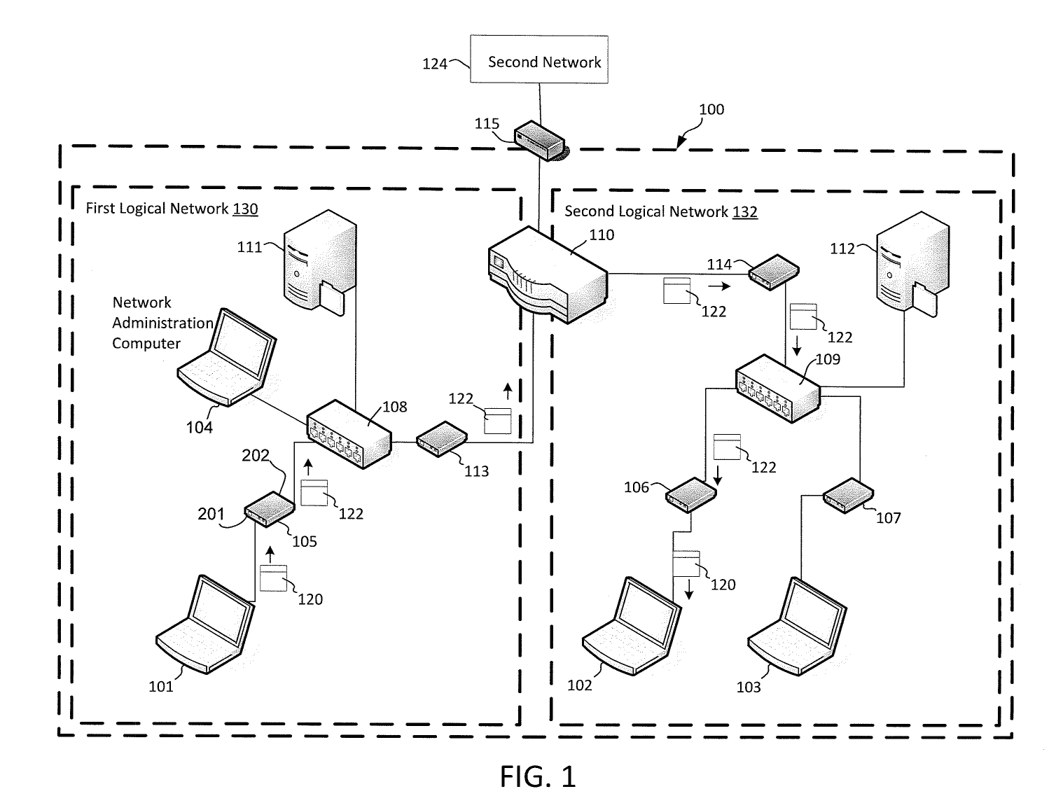

Referring now to FIG. 1, there is shown a diagram of an exemplary network 100 which includes a plurality of computing devices. The computing devices can include client computers 101-103, network administration computer (NAC) 104, servers 111, 112, network hubs 108, 109, router 110, and a bridge 115. The client computers can be any type of computing device which might require network services, such as a conventional tablet, notebook, laptop or desktop computer. The router 110 can be a conventional routing device that routes data packets between computer networks. The hubs 108, 109 are conventional hub devices (e.g. an Ethernet hub) as are well known in the art. Servers 111, 112 can provide various computing services utilized by client computers 101-103. For example, the servers 111, 112 can be file servers which provide a location for shared storage of computer files used by client computers 101-103.

The communication media for the network 100 can be wired, wireless or both, but shall be described herein as a wired network for simplicity and to avoid obscuring the invention. The network will communicate data using a communication protocol. As is well known in the art, the communication protocol defines the formats and rules used for communicating data throughout the network. The network in FIG. 1 can use any communication protocol or combination of protocols which is now known or known in the future. For example, the network can use the well known Ethernet protocol suite for such communications. Alternatively, the network can make use of other protocols, such as the Internet Protocol Suite (often referred to as TCP/IP), SONET/SDH, or Asynchronous Transfer Mode (ATM) communication protocols. In some embodiments, one or more of these communication protocols can be used in combination. Although one network topology is shown in FIG. 1, the invention is not limited in this regard. Instead, any type of suitable network topology can be used, such as a bus network, a star network, a ring network or a mesh network.

The invention generally concerns a method for communicating data in a computer network (e.g. in computer network 100), where data is communicated from a first computing device to a second computing device. Computing devices within the network are represented with multiple identity parameters. The phrase “identity parameters” as used herein can include items such as an internet protocol (IP) address, media access control (MAC) address, ports and so on. However, the invention is not limited in this regard, and identity parameters can also include a variety of other information which is useful for characterizing a network node. The various types of identity parameters contemplated herein are discussed below in further detail. The inventive arrangement involve the use of moving target technology (MTT) to manipulate one or more of such identity parameters for one or more computing devices within the network. This technique disguises communication patterns and network address of such computing devices. The manipulation of identity parameters as described herein is generally performed in conjunction with data communications in the network, i.e. when data is to be communicated from a first computer in the network (e.g. client computer 101) to a second computer in the network (e.g. client computer 102). Accordingly, identity parameters that are manipulated can include those of a source computing device (the device from which the data originated) and the destination computing device (the device to which the data is being sent). The set of identity parameter that are communicated is referred to herein as an identity parameter set (IDP set). This concept is illustrated in FIG. 1, which shows that an IDP set 120 is transmitted by client computer 101 as part of a data packet (not shown).

The process according to the inventive arrangements involves selectively modifying at a first location within the computer network, values contained in a data packet or datagram which specify one or more identify parameters of a source and/or destination computing device. The identity parameters are modified in accordance with a mission plan. The location where such modification is performed will generally coincide with the location of one of the modules 105-107, 113, 114. Referring once again to FIG. 1, it can be observed that modules 105, 106, 107, 113, 114 are interposed in the network between the various computing devices which comprise nodes in such network. In these locations, the modules intercept data packet communications, perform the necessary manipulations of identity parameters, and retransmit the data packets along a transmission path. In alternative embodiments, the modules 105, 106, 107, 113, 114 can perform a similar function, but can be integrated directly into one or more of the computing devices. For example, the modules could be integrated into client computers 101, 102, 103, servers 111, 112, hubs 108, 109, bridge 115, and/or within router 110. Hubs 108, 109, bridge 115 and/or router 110 can also include a firewall that is capable of filtering traffic that includes a modified IDP set.

Additionally, network 100 can be divided into a number of logical subdivisions, sometimes referred to as sub-networks or subnets, connected through router 110. An enterprise network can be divided into a number of subnets for a variety of administrative or technical reasons including, but not limited to, hiding the topology of the network from being visible to external hosts, connecting networks utilizing different network protocols, separately administering network addressing schemes on the subnet level, enabling management of data traffic across subnets due to constrained data connections, and the like. Subnetting is well known in the art and will not be described in further detail.

Referring again to FIG. 1, network 100 is divided into two logical networks, a first logical network 130 and a second logical network 132. The phrase “logical network” as used herein refers to any logical subdivision of a computer network. In an embodiment, logical networks 130, 132 are connected through router 110. Router 110 is responsible for directing traffic between the logical networks, i.e. from client computer 101 to client computer 103. Router 110 is also responsible for directing traffic from any host connected to network 100 bound for second network 124. In the embodiment shown in FIG. 1, traffic routed from network 100 to second network 124 passes through bridge 115. As with the modules above, the functionality of the bridge 115 could be integrated within router 110 and/or include a firewall.

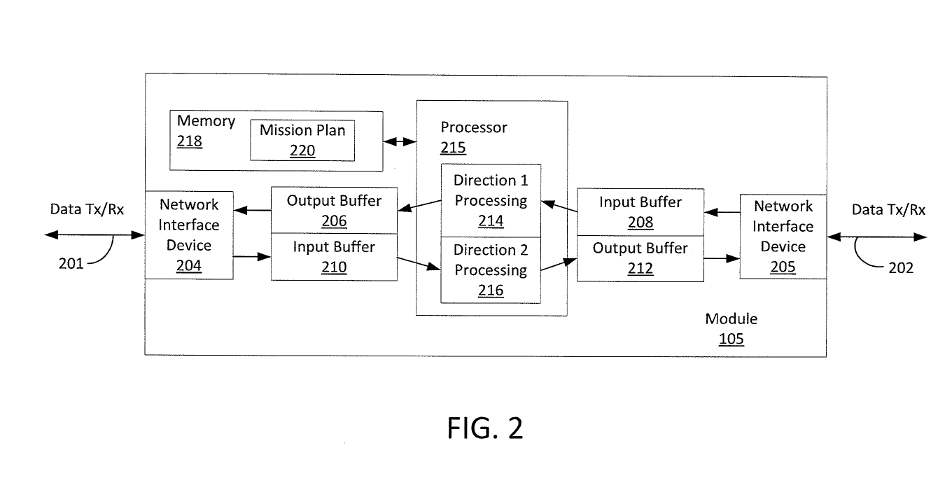

A example of a functional block diagram of a module 105 is shown in FIG. 2. Modules 106-107, 113, 114 can have a similar functional block diagram, but it should be understood that the invention is not limited in this regard. As shown in FIG. 2, the module 105 has at least two data ports 201, 202, each of which can correspond to a respective network interface device 204, 205. Data received at port 201 is processed at network interface device 204 and temporarily stored at an input buffer 210. The processor 215 accesses the input data packets contained in input buffer 210 and performs any necessary manipulation of identity parameters as described herein. The modified data packets are passed to output buffer 212 and subsequently transmitted from port 202 using network interface device 205. Similarly, data received at port 202 is processed at network interface device 205 and temporarily stored at an input buffer 208. The processor 215 accesses the input data packets contained in input buffer 208 and performs any necessary manipulation of identity parameters as described herein. The modified data packets are passed to output buffer 206 and subsequently transmitted from port 201 using network interface device 204. In each module, manipulation of identity parameters is performed by processor 215 in accordance with a mission plan 220 stored in a memory 218.

It will be understood from FIG. 2 that a module is preferably configured so that it operates bi-directionally. In such embodiments, the module can implement different modification functions, depending on a source of a particular data packet. The dynamic modification function in each module can be specified in the mission plan in accordance with a source computing device of a particular data packet. Modules can determine a source of data packets by any suitable means. For example, a source address of a data packet can be used for this purpose.

At a selected module within the network 100, processor 215 will determine one or more false identity parameter values that are to be used in place of the true identity parameter values. The processor will transform one or more true identity parameter values to one or more false identity parameter values which are preferably specified by a pseudorandom function. Following this transformation, the module will forward the modified packet or datagram to the next node of the network along a transmission path. At subsequent points in the communication path, an adversary who is monitoring such network communications will observe false or incorrect information about the identity of computing devices communicating on the network.

In a preferred embodiment, the false identity parameters that are specified by the pseudorandom function are varied in accordance with the occurrence of one or more trigger events. The trigger event causes the processor 215 to use the pseudorandom function to generate a new set of false identity parameter values into which the true identity parameters are transformed. Accordingly, the trigger event serves as a basis for the dynamic variation of the false identity parameters described herein. Trigger events are discussed in more detail below. However it should be noted that trigger events for selecting a new set of false values for identity parameters can be based on the passage of time and/or the occurrence of certain network events. Trigger events can also be initiated by a user command.

The transformation of identity parameters described above provides one way to maneuver a computer network 100 for purposes of thwarting a cyber attack. In a preferred embodiment, the mission plan 220 implemented by processor 215 will also control certain other aspects of the manner in which computer network can maneuver. For example, the mission plan can specify that a dynamic selection of identity parameters are manipulated. The dynamic selection can include a choice of which identity parameters are selected for modification, and/or a number of such identity parameters that are selected. This variable selection process provides an added dimension of uncertainty or variation which can be used to further thwart an adversary's effort to infiltrate or learn about a computer network 100. As an example of this technique, consider that during a first time period, a module can modify a destination IP address and a destination MAC address of each data packet. During a second time period the module could manipulate the source IP address and a source host name in each data packet. During a third period of time the module could manipulate a source port number and a source user name. Changes in the selection of identity parameters can occur synchronously (all selected identity parameters are changed at the same time). Alternatively, changes in the selection of identity parameters can occur asynchronously (the group of selected identity parameters changes incrementally as individual identity parameters are added or removed from the group of selected identity parameters).

A pseudorandom function is preferably used for determining the selection of identity values that are to be manipulated or transformed into false values. In other words, the module will transform only the identity parameters selected by the pseudo-random function. In a preferred embodiment, the selection of identity parameters that are specified by the pseudorandom function is varied in accordance with the occurrence of a trigger event. The trigger event causes processor 215 use a pseudorandom function to generate a new selection of identity parameters which are to be transformed into false identity parameters. Accordingly, the trigger event serves as a basis for the dynamic variation of the selection of identity parameters described herein. Notably, the values of the identity parameters can also be varied in accordance with pseudorandom algorithm.

The modules are advantageously capable of also providing a third method of maneuvering the computer network for purposes of thwarting a cyber attack. Specifically, the mission plan loaded in each module can dynamically vary the location within the network where the modification or transformation of the identity parameters takes place. Consider that modification of identity parameters in an IDP set 120 sent from client computer 101 to client computer 102, could occur in module 105. This condition is shown in FIG. 1, where the identity parameters contained in IDP set 120 are manipulated in module 105 so that IDP set 120 is transformed to a new or modified IDP set 122. At least some of the identity parameters in IDP set 122 are different as compared to the identity parameters in IDP set 120. But the location where such transformation occurs is preferably also controlled by the mission plan. Accordingly, manipulation of IDP set 120 could, for example, sometimes occur at module 113 or 114, instead of at module 105. This ability to selectively vary the location where manipulation of identity parameters occurs adds a further important dimension to the maneuvering capability of the computer network.

The dynamic variation in the location where identity parameters are modified is facilitated by selectively controlling an operating state of each module. To that end, the operational states of each module preferably includes (1) an active state in which data is processed in accordance with a current mission plan, and (2) a by-pass state in which packets can flow through the module as if the module was not present. The location where the dynamic modification is performed is controlled by selectively causing certain modules to be in an active state and certain modules to be in a standby state. The location can be dynamically changed by dynamically varying the current state of the modules in a coordinated manner.

The mission plan can include predefined sequence for determining the locations within the computer network 100 where identity parameters are to be manipulated. Locations where identity parameters are to be manipulated will change in accordance with the sequence at times indicated by a trigger event. For example, the trigger event can cause a transition to a new location for manipulation or transformation of identity parameters as described herein. Accordingly, the trigger event serves as a basis for the occurrence of a change in the location where identity parameters are modified, and the predefined sequence determines where the new location will be.

From the foregoing, it will be appreciated that a data packet is modified at a module to include false identity parameters. At some point within the computer network, it is necessary to restore the identity parameters to their true values, so that the identity parameters can be used to properly perform their intended function in accordance with the particular network protocol. Accordingly, the inventive arrangements also includes dynamically modifying, at a second location (i.e. a second module), the assigned values for the identity parameters in accordance with the mission plan. The modification at the second location essentially comprises an inverse of a process used at the first location to modify the identity parameters. The module at the second location can thus restore or transform the false value identity parameters back to their true values. In order to accomplish this action, the module at the second location must be able to determine at least (1) a selection of identity parameter value that are to be transformed, and (2) a correct transformation of the selected identity parameters from false values to true values. In effect, this process involves an inverse of the pseudorandom process or processes used to determine the identity parameter selection and the changes effected to such identity parameter values. The inverse transformation step is illustrated in FIG. 1, where the IDP set 122 is received at module 106, and the identity parameter values in IDP set 122 are transformed or manipulated back to their original or true values. In this scenario, module 106 converts the identity parameters values back to those of IDP set 120.

Notably, a module must have some way of determining the proper transformation or manipulation to apply to each data communication it receives. In a preferred embodiment, this determination is performed by examining at least a source address identity parameter contained within the received data communication. For example, the source address identity parameter can include an IP address of a source computing device. Once the true identity of the source computing device is known, the module consults the mission plan (or information derived from the mission plan) to determine what actions it needs to take. For example, these actions could include converting certain true identity parameter values to false identity parameter values. Alternatively, these changes could include converting false identity parameter values back to true identity parameter values.

Notably, there will be instances where the source address identity parameter information contained in a received data communication has been changed to a false value. In those circumstances, the module receiving the data communication will not immediately be able to determine the identity of the source of the data communication. However, the module which received the communication can in such instances still identify the source computing device. This is accomplished at the receiving module by comparing the false source address identity parameter value to a look-up-table (LUT) which lists all such false source address identity parameter values in use during a particular time. The LUT also includes a list of true source address identity parameter values that correspond to the false source address values. The LUT can be provided directly by the mission plan or can be generated by information contained within the mission plan. In either case, the identification of a true source address identity parameter value can be easily determined from the LUT. Once the true source address identity parameter has been determined, then the module which received the data communication can use this information to determine (based on the mission plan) what manipulations to the identity parameters are needed.

Notably, the mission plan can also specify a variation in the second location where identity parameters are restored to their true values. For example, assume that the identity parameters are dynamically modified at a first location comprising module 105. The mission plan can specify that the restoration of the identity parameters to their true values occurs at module 106 as described, but can alternatively specify that dynamic modification occur instead at module 113 or 114. In some embodiments, the location where such manipulations occur is dynamically determined by the mission plan in accordance with a predefined sequence. The predefined sequence can determine the sequence of locations or modules where the manipulation of identity parameters will occur.

The transition involving dynamic modification at different locations preferably occurs in accordance with a trigger event. Accordingly, the predefined sequence determines the pattern or sequence of locations where data manipulations will occur, and the trigger event serves as a basis for causing the transition from one location to the next. Trigger events are discussed in more detail below; however, it should be noted that trigger events can be based on the passage of time, user control, and/or the occurrence of certain network events. Control over the choice of a second location (i.e. where identity parameters are returned to their true values) can be effected in the same manner as described above with regard to the first location. Specifically, operating states of two or more modules can be toggled between an active state and a bypass state. Manipulation of identity parameters will only occur in the module which has an active operating state. The module with a bypass operating state will simply pass data packets without modification.

Alternative methods can also be used for controlling the location where manipulation of identity parameters will occur. For example, a network administrator can define in a mission plan several possible modules where a identity parameters can be converted from true values to false values. Upon the occurrence of a trigger event, a new location can be selected from among the several modules by using a pseudorandom function, and using a trigger time as a seed value for the pseudorandom function. If each module implements the same pseudorandom function using the same initial seed values then each module will calculate the same pseudorandom value. The trigger time can be determined based on a clock time, such as a GPS time or system clock time). In this way, each module can independently determine whether it is currently an active location where manipulation of identity parameters should occur. Similarly, the network administrator can define in a mission plan several possible modules where dynamic manipulation returns the identity parameters to their correct or true values. The selection of which module is used for this purpose can also be determined in accordance with a trigger time and a pseudorandom function as described herein. Other methods are also possible for determining the location or module where identity parameter manipulations are to occur. Accordingly, the invention is not intended to be limited to the particular methods described herein.

Notably, varying the position of the first and/or second locations where identity functions are manipulated will often result in varying a physical distance between the first and second location along a network communication path. The distance between the first and second locations is referred to herein as a distance vector. The distance vector can be an actual physical distance along a communication path between the first and second location. However, it is useful to think of the distance vector as representing the number of network nodes that are present in a communication path between the first and second locations. It will be appreciated that dynamically choosing different position for the first and second locations within the network can have the effect of changing the number of nodes between the first and second locations. For example, in FIG. 1 the dynamic modification of identity parameters are implemented in selected ones of the modules 105, 106, 107, 113, 114. The modules actually used to respectively implement the dynamic modification is determined as previously described. If module 105 is used for converting identity parameters to false values and module 106 is used to convert them back to true values, then there are three network nodes (108, 110, 109) between modules 105 and 106. But if module 113 is used to convert to false values and module 114 is used to convert the identity parameters back to true values, then there is only one network node (110) between modules 113 and 114. Accordingly, it will be appreciated that dynamically changing the position of locations where dynamic modification occurs can dynamically vary the distance vector. This variation of the distance vector provides an added dimension of variability to network maneuvering or modification as described herein.

In the present invention, the manipulation of identity parameter values, the selection of identity parameters, and the locations where these identity parameters is each defined as a maneuvering parameter. Whenever a change occurs in one of these three maneuvering parameters, it can be said that a network maneuver has occurred. Any time one of these three maneuvering parameters is changed, we can say that a network maneuver has occurred. In order to most effectively thwart an adversary's efforts to infiltrate a computer network 100, network maneuvering is preferably controlled by means of a pseudorandom process as previously described. Those skilled in the art will appreciate that a chaotic process can also be used for performing this function. Chaotic processes are technically different as compared to pseudorandom functions, but for purposes of the present invention, either can be used, and the two are considered equivalent. In some embodiments, the same pseudorandom process can be used for dynamically varying two or more of the maneuvering parameters. However, in a preferred embodiment of the invention, two or more different pseudorandom processes are used so that two or more of these maneuvering parameters are modified independently of the others.

### Trigger Events

As noted above, the dynamic changes to each of the maneuvering parameters is controlled by at least one trigger. A trigger is an event that causes a change to occur in relation to the dynamic modifications described herein. Stated differently, it can be said that the trigger causes the network to maneuver in a new way that is different than at a previous time (i.e. before the occurrence of the trigger). For example, during a first period of time, a mission plan can cause an IP address can be changed from value A to value B; but after the trigger event, the IP address can instead be changed from value A to value C. Similarly, during a first period of time a mission plan can cause an IP and MAC address to be modified; but after the trigger event, the mission plan can instead cause a MAC address and user name to be modified. As a third example, consider that during a first period of time a mission plan may cause identity parameters to be changed when an IDP set 120 arrives at module 105; but after the trigger event, can cause the identity parameters to instead be changed when and IDP set 120 arrives at module 113.

In its simplest form a trigger can be user activated or based on a simple timing scheme. In such an embodiment, a clock time in each module could serve as a trigger. For example, a trigger event could be defined as occurring at the expiration of every 60 second time interval. For such an arrangement, one or more of the maneuvering parameters could change every 60 seconds in accordance with a predetermined clock time. In some embodiments, all of the maneuvering parameters can change concurrently so that the changes are synchronized. In a slightly more complex embodiment, a time-based trigger arrangement can also be used, but a different unique trigger time interval can be selected for each maneuvering parameter. Thus, false identity parameter values could be changed at time interval X, a selection of identity parameters would change in accordance with a time interval Y, and a location where such changes are performed would occur at time interval Z, where X, Y and Z are different values.

It will be appreciated that in embodiments of the invention which rely upon clock time as a trigger mechanism, it is advantageous to provide synchronization as between the clocks in various modules 105, 106, 107, 113, 114 to ensure that packets are not lost or dropped due to unrecognized identity parameters. Synchronization methods are well known and any suitable synchronization mechanism can be used for this purpose. For example, the modules could be synchronized by using a highly accurate time reference such as a GPS clock time. Alternatively, a unique wireless synchronization signal could be broadcast to each of the modules from a central control facility.

Other types of triggers are also possible with the present invention. For example, trigger events can be based on the occurrence or detection of potential network security threats. According to an embodiment of the invention, a potential network security threat can be identified by a network security software suite. Alternatively, the potential network security threat can be identified upon the receipt of a data packet at a module 105, 106, 107, 113, 114 where the packet contains one or more identity parameters that are inconsistent with the present state of network maneuvering. Regardless of the basis for identifying a network security threat, the existence of such threat can serve as a trigger event. A trigger event based on a network security threat can cause the same types of network maneuvers as those caused by the time based triggers described above. For example, false identity parameters, the selection of identity parameters and the locations of identity parameter transformations could remain stable (i.e. unchanged) except in the case were a network security threat was detected. Such an arrangement might be chosen, for example, in computer networks where frequent network maneuvering is not desirable.

Alternatively, time based trigger events can be combined with trigger events based on potential threats to network security. In such embodiments, a trigger event based on a security threat can have a different effect on the network maneuvering as compared to time based triggers. For example, a security threat-based trigger event can cause strategic or defensive changes in the network maneuvering so as to more aggressively counter such network security threat. The precise nature of such measures can depend on the nature of the threat, but can include a variety of responses. For example, different pseudorandom algorithms can be selected, and/or the number of identity parameters selected for manipulation in each IDP set 120 can be increased. In systems that already make use of time based triggers, the response can also include increasing a frequency of network maneuvering. Thus, more frequent changes can be made with respect to (1) the false identity parameter values, (2) the selection of identity parameters to be changed in each IDP set, and/or (3) the position of the first and second locations where identity parameters are changed. Accordingly, the network maneuvering described herein provides a method for identifying potential network security threats and responding to same.

### Mission Plans

According to a preferred embodiment of the invention, the network maneuvering described herein is controlled in accordance with a mission plan. A mission plan is a schema that defines and controls maneuverability within the context of a network and a security model. As such, the mission plan can be represented as a data file that is communicated from the network administration computer (NAC) 104 to each module 105-107, 113-114. The mission plan is thereafter used by each module to control the manipulation of identity parameters and coordinate its activities with the actions of the other modules in the network.

According to a preferred embodiment, the mission plan can be modified from time to time by a network administrator to update or change the way in which the network maneuvers to thwart potential adversaries. As such, the mission plan provides a network administrator with a tool that facilitates complete control over the time, place and manner in which network maneuvering will occur within the network. Such update ability allows the network administrator to tailor the behavior of the computer network to the current operating conditions and more effectively thwart adversary efforts to infiltrate the network. Multiple mission plans can be defined by a user and stored so that they are accessible to modules within the network. For example, the multiple mission plans can be stored at NAC 104 and communicated to modules as needed. Alternatively, a plurality of mission plans can be stored on each module and can be activated as necessary or desirable to maintain security of the network. For example, if the network administrator determines or suspects that an adversary has discovered a current mission plan for a network, the administrator may wish to change the mission plan. Effective security procedures can also dictate that the mission plan be periodically changed.

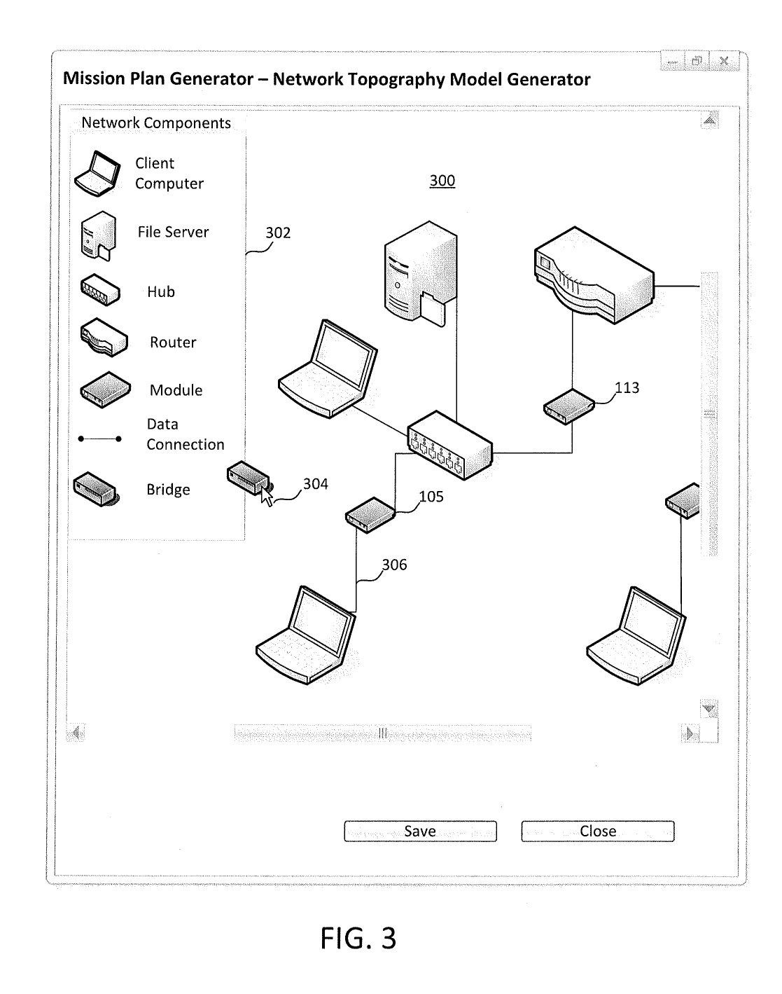

The process of creating a mission plan can begin by modeling the network 100. The creation of the model is facilitated by a network control software application (NCSA) executing on a computer or server at the network command center. For example, in the embodiment shown in FIG. 1, the NCSA can execute on NAC 104. The network model preferably includes information which defines data connections and/or relationships between various computing devices included in the network 100. The NCSA will provide a suitable interface which facilitates entry of such relationship data. According to one embodiment, the NCSA can facilitate entry of data into tables which can be used to define the mission plan. However, in a preferred embodiment, a graphic user interface is used to facilitate this process. Referring now to FIG. 3, the NCSA can include a network topography model generator tool. The tool is used to assist the network administrator in defining the relationship between each of the various components of the networks. The network topography tool provides a workspace 300 in which an administrator can drag and drop network components 302, by using a cursor 304. The network administrator can also create data connections 306 between various network components 302. As part of this modeling process, the network administrator can provide network address information for the various network components, including the modules 105-107, 113, 114.

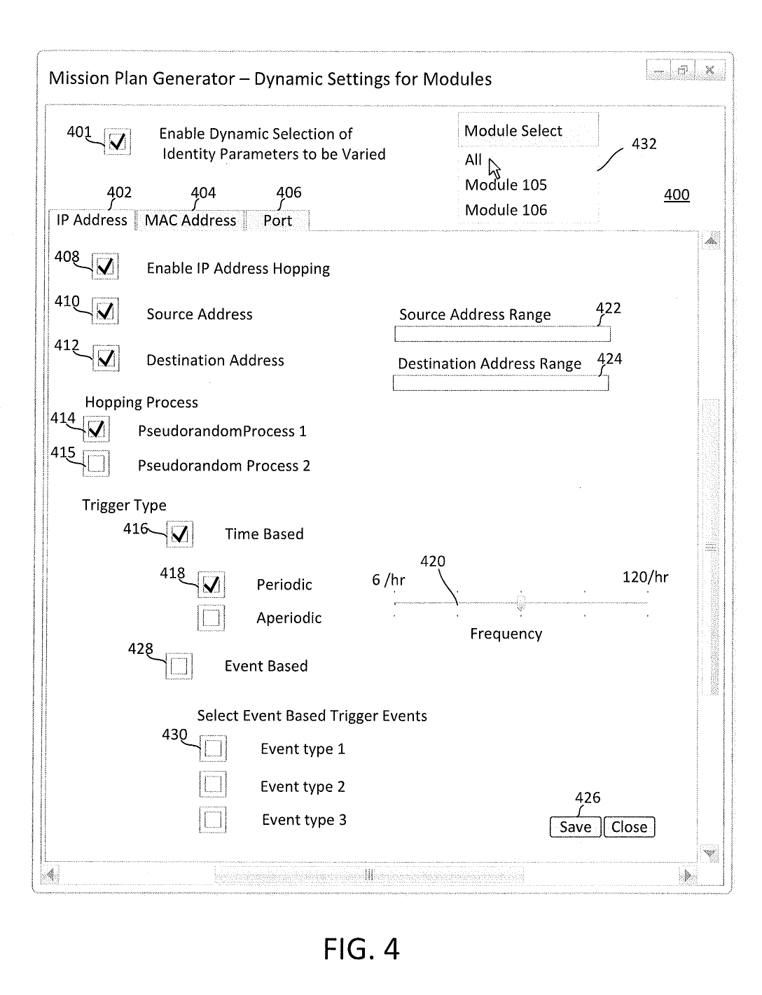

Once the network has been modeled, it can be saved and used by the network administrator to define the manner in which the various modules 105-107, 113, 114 behave and interact with one another. Referring now to FIG. 4, the NCSA can generate a dialog box 400 of which can be used to further develop a mission plan. A drop-down menu 432 can be used to select the particular module (e.g. module 105) to which the settings in dialog box 400 are to be applied. Alternatively, the network administrator can use drop-down menu 432 to indicate that the settings in dialog box 400 are intended to be applied to all modules within the network (e.g. by selecting “All” in menu 432). The process can continue by specifying whether a fixed set of identity parameters will always be modified in each of the modules, or whether the set of identity parameters that are manipulated shall be dynamically varied. If the selection or set of identity parameters that are to be manipulated in the modules is intended to be dynamically varied, the network administrator can mark check-box 401 to indicate that preference. If the check-box 401 is not marked, that will indicate that the set of identity parameters to be varied is a fixed set that does not vary over time.

The dialog box 400 includes tabs 402, 404, 406 which allow a user to select the particular identity parameter that he wants to work with for purposes of creating a mission plan. For purposes of this disclosure, the dialog box 400 facilitates dynamic variation of only three identity parameters. Specifically, these include the IP address, MAC address and Port Address. More or fewer identity parameters can be dynamically varied by providing additional tabs, but the three identity parameters noted are sufficient to explain the inventive concepts. In FIG. 4, the user has selected the tab 402 to work with the IP Address type of identity parameter. Within tab 402, a variety of user interface controls 408-420 are provided for specifying the details relating to the dynamic variation of IP addresses within the selected module. More or fewer controls can be provided to facilitate the dynamic manipulation of the IP Address type, and the controls shown are merely provided to assist the reader in understanding the concept. In the example shown, the network administrator can enable dynamic variation of IP addresses by selecting (e.g. with a pointing device such as a mouse) the check-box 408 marked: Enable IP Address Hopping. Similarly, the network administrator can indicate whether the source address, destination address or both are to be varied. In this example, the source and destination address boxes 410, 412 are both marked, indicating that both types of addresses are to be changed. The range of allowed values for the source and destination addresses can be specified by the administrator in list boxes 422, 424.

The particular pseudorandom process used to select false IP address values is specified by selecting a pseudorandom process. This selection is specified in boxes 414, 415. Different pseudorandom processes can have different levels of complexity for variable degrees of true randomness, and the administrator can choose the process that best suits the needs of the network 100.

Dialog box 400 also allows a network administrator to set the trigger type to be used for the dynamic variation of the IP Address identity parameter. In this example, the user has selected box 416, indicating that a time based trigger is to be used for determining when to transition to new false IP address values. Moreover, checkbox 418 has been selected to indicate that the time based trigger is to occur on a periodic basis. Slider 420 can be adjusted by the user to determine the frequency of the periodic time based trigger. In the example shown, the trigger frequency can be adjusted between 6 trigger occurrences per hour (trigger every 10 minutes) and 120 trigger occurrences per hour (trigger every 30 seconds). In this example, selections are available for other types of triggers as well. For example, dialog box 402 includes check boxes 428, 430 by which the network administrator can select an event-based trigger. Several different specific event types can be selected to form the basis for such event-based triggers (e.g. Event type 1, Event type 2, etc.). These event types can include the detection of various potential computer network security threats. In FIG. 4, tabs 404 and 406 are similar to tab 402, but the controls therein are tailored to the dynamic variation of the MAC Address and Port value rather than the IP Address. Additional tabs could be provided for controlling the dynamic variation of other types of identity parameters.

The mission plan can also specify a plan for dynamically varying the location where identity parameters are modified. In some embodiments, this variable location feature is facilitated by controlling a sequence that defines when each module is in an active state or a bypass state. Accordingly, the mission plan advantageously includes some means of specifying this sequence. In some embodiments of the invention, this can involve the use of defined time intervals or time slots, which are separated by the occurrence of a trigger event.

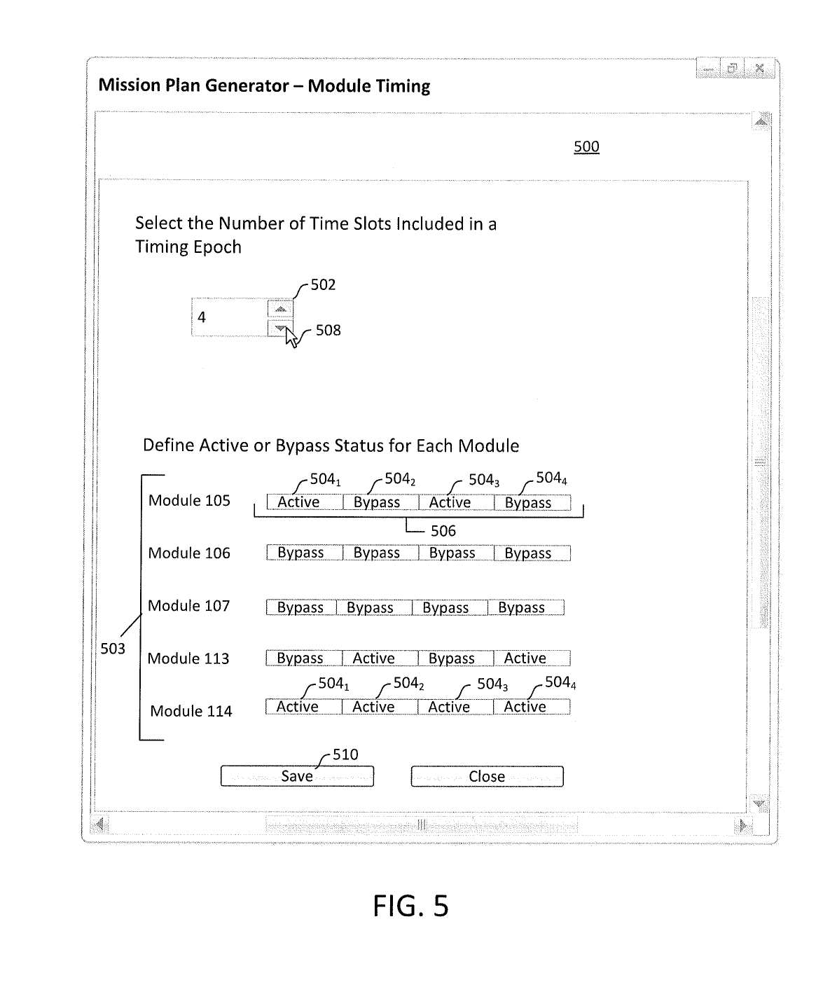

Referring now to FIG. 5, a dialog box 500 can be provided by the NCSA to facilitate coordination and entry of location sequence and timing information. Dialog box 500 can include a control 502 for selecting a number of time slots 504₁-504ₙ which are to be included within a time epoch 506. In the example illustrated, the network administrator has defined 4 time slots per timing epoch. The dialog box 500 can also include a table 503 which includes all modules in the network 100. For each module listed, the table includes a graphical representation of available time slots 504₁-504₄ for one timing epoch 506. Recall that dynamic control over the location where identity parameters are manipulated is determined by whether each module is in an active or bypass operating states. Accordingly, within the graphical user interface, the user can move a cursor 508 and make selections to specify whether a particular module is in an active or bypass mode during each time slot. In the example shown, module 105 is active during time slot 504₁ and 504₃, but is in a bypass mode during time slots 504₂, 504₄. Conversely, module 113 is active during time slots 504₂, 504₄, but is in bypass mode during time slots 504₁ and 504₃. With reference to FIG. 1, this means that manipulation of identity parameters occurs at a location associated with module 105 during time slots slot 504₁ and 504₃, but occurs instead at module 113 during time slots 504₂, 504₄.

In the example shown in FIG. 5, the network administrator has elected to have module 114 always operate in an active mode (i.e. module 114 is active during all time slots. Accordingly, for data communications transmitted from client computer 101 to client computer 103, data packets will alternately be manipulated in modules 105, 113, but will always be manipulated at module 114. Finally, in this example, the network administrator has elected to maintain modules 106 and 107 in a bypass mode during time slots 504₁-504₄. Accordingly, no manipulation of identity parameters will be performed at these modules during any of the defined time slots. Once the module timing has been defined in dialog box 500, the network administrator can select the button 510 to store the changes as part of an updated mission plan. The mission plan can be saved in various formats. In some embodiments, the mission plan can be saved as a simple table or other type of defined data structure that can be used by each module for controlling the behavior of the module.

### Distribution and Loading of Mission Plans

The distribution and loading of mission plans as disclosed herein will now be described in further detail. Referring once again to FIG. 1, it can be observed that the modules 105-107, 113, 114 are distributed throughout the network 100 at one or more locations. The modules are integrated within the communications pathways to intercept communications at such locations, perform the necessary manipulations, and forward data to other computing devices within the network. With the foregoing arrangement, any necessary maintenance of the modules described herein (e.g. maintenance to update a mission plan) will have the potential to disrupt network communications while the modules are replaced or reprogrammed. Such disruptions are undesirable in many situations where reliability and availability of network services is essential. For example, uninterrupted network operation can be essential for computer networks used by military, emergency services and businesses.

In order to ensure uninterrupted network operations, each module preferably has several operating states. These operating states include (1) an off state in which the module is powered down and does not process any packets, (2) an initialization state in which the module installs software scripts in accordance with the mission plan, (3) an active state in which data is processed in accordance with a current mission plan, and (4) a by-pass state in which packets can flow through the module as if the module was not present. The module is configured so that, when it is in the active state or the by-pass state, the module can receive and load an updated mission plan provided by a network administrator. The module operating states can be manually controlled by the network administrator by means of the NCSA executing, for example, on NAC 104. For example, the user can select operating states for various modules through the use of a graphical user interface control panel. Commands for controlling the operating states of the network are communicated over the network 100, or can be communicated by any other suitable means. For example, a separate wired or wireless network (not shown) can be used for that purpose.

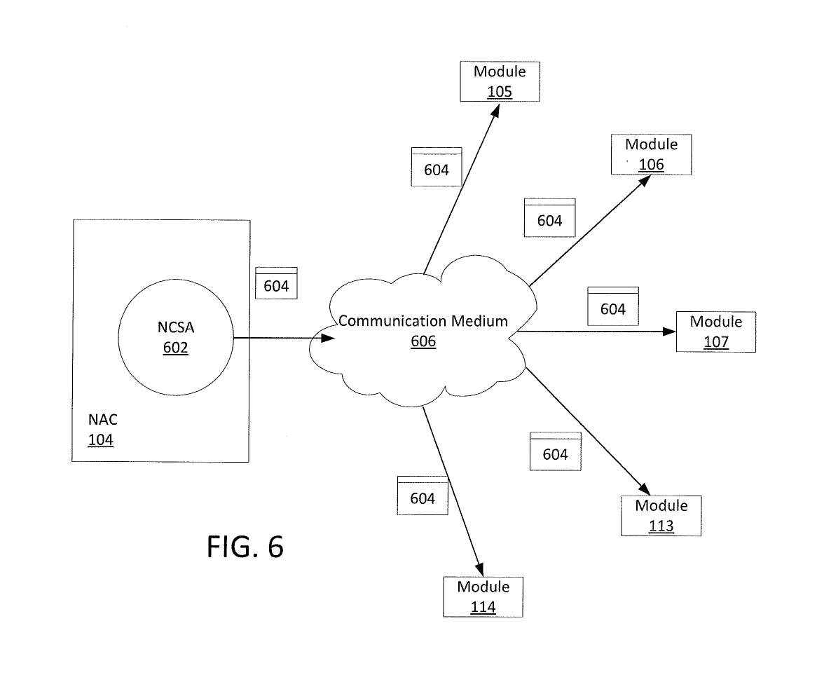

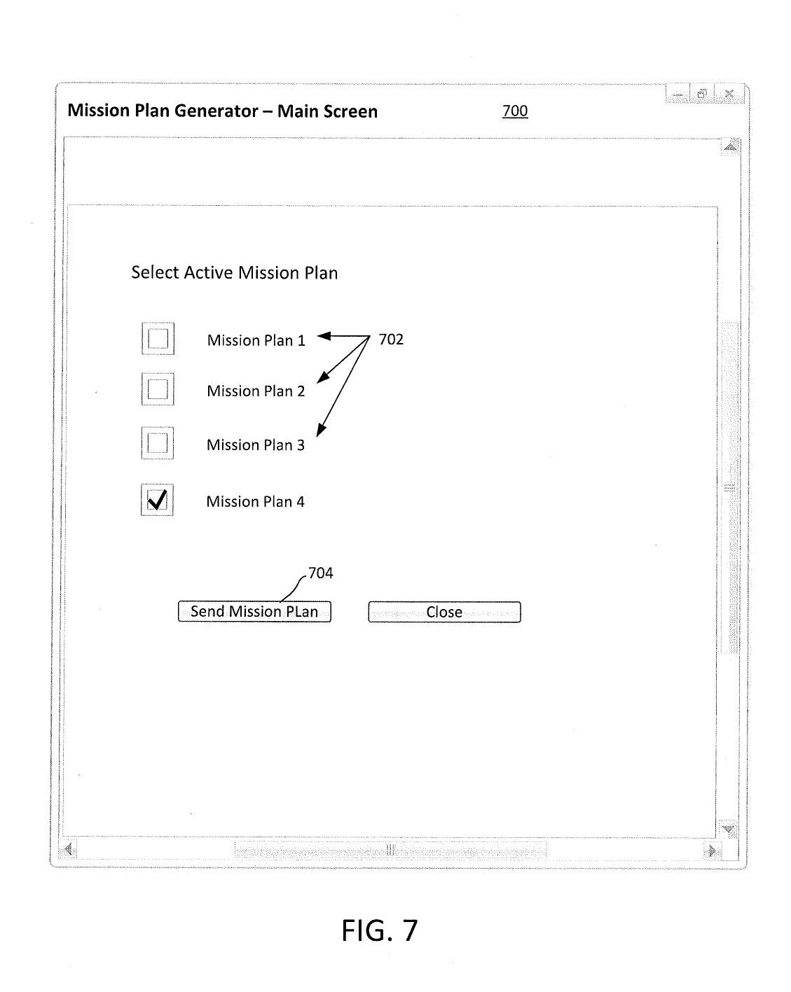

The mission plan can be loaded directly at the physical location of each module, or it can be communicated to the module from the NCSA. This concept is illustrated in FIG. 6, which shows mission plans 604 being communicated from NCSA 602 to each of the modules 105-107, 113, 114 over a communication medium 606. In the example shown, the NCSA software application is executing on NAC 104 operated by a network administrator. The communication medium can in some embodiments include in-band signaling using computer network 100. Alternatively, an out-of-band network (e.g. a separate wireless network) can be used as the communication medium 606 to communicate the updated mission plan from the NCSA to each module. As shown in FIG. 7, the NCSA can provide a dialog box 700 to facilitate selection of one of several mission plans 702. Each of these mission plans 702 can be stored on NAC 104. The network administrator can select from one of the several mission plans 702, after which they can activate a Send Mission Plan button 704. Alternatively, a plurality of mission plans can be communicated to each module and stored there. In either scenario, the user can choose one of the defined mission plans to activate.

In response to the command to send the mission plan, the selected mission plan is communicated to the modules while they are in an active state in which they are configured for actively performing dynamic modification of identity parameters as described herein. Such an arrangement minimizes the time during which the network operates in the clear and without manipulating identity parameters. However, the updated mission plan can also be communicated to the modules while they are in the by-pass mode, and this approach may be desirable in certain cases.

Once the mission plan is received by a module, it is automatically stored in a memory location within the module. Thereafter, the module can be caused to enter the by-pass state and, while still in that state, the module can load the data associated with the new mission plan. This process of entering into the by-pass state and loading the new mission plan data can occur automatically in response to receipt of the mission plan, or can occur in response to a command from the NCSA software controlled by the network administrator. The new mission plan preferably includes changes in the way that identity parameter values are varied. Once the new mission plan has been loaded, the modules 105-107, 113, and 114 can be transitioned from the by-pass mode to the active mode in a synchronized way to ensure that data communication errors do not occur. The mission plan can specify a time when the modules are to return to the active mode, or the network administrator can use the NCSA to communicate a command to the various modules, directing them to enter into the active mode. The foregoing process of updating a mission plan advantageously allows changes in network security procedures to occur without disrupting communication among the various computing devices attached to the computer network 100.

The dynamic manipulation of various identity parameters at each module 105, 106, 107, 113, and 114 is preferably controlled by the application software executing on each module 105-107, 113, 114. However, the behavior of the application software is advantageously controlled by the mission plan.

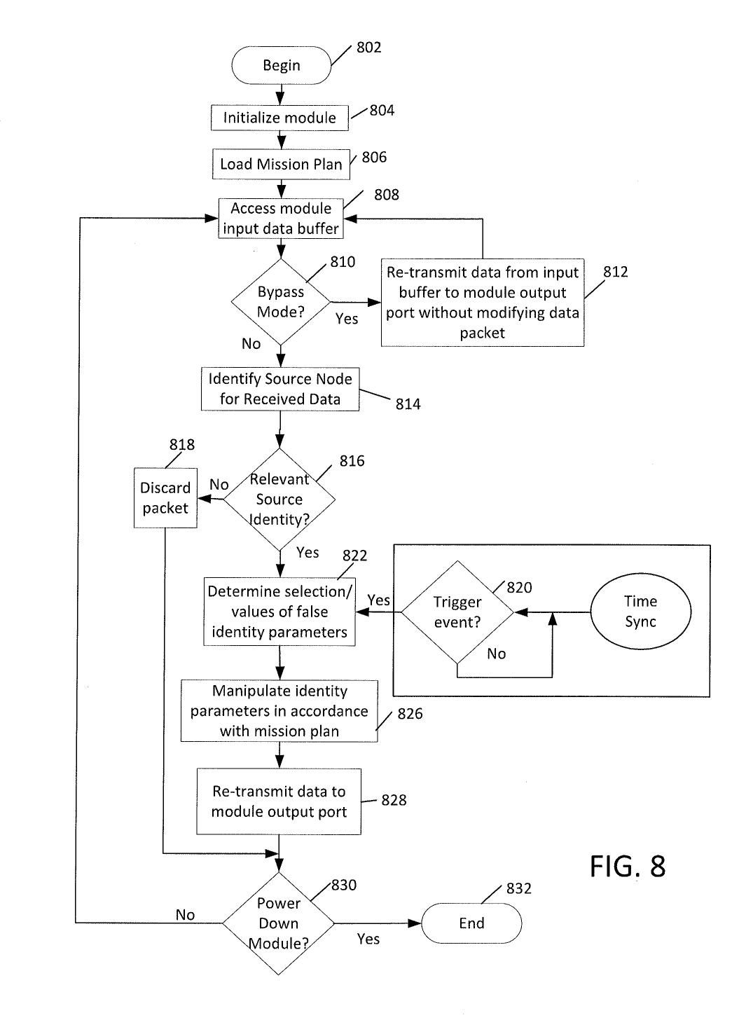

Referring now to FIG. 8, there is provided a flowchart which summarizes the operation of each module 105-107, 113, 114. To avoid confusion, the process is described with respect to communications in a single direction. For example in the case of module 105, the single direction could involve data transmitted from client computer 101 to hub 108. In practice however, it is preferred that modules 105-107, 113, 114 operate bi-directionally. The process begins at step 802 when the module is powered up and continues to step 804 where module application software is initialized for executing the methods described herein. In step 806, a mission plan is loaded from a memory location within the module. At this point, the module is ready to begin processing data and proceeds to do so at step 808, where it accesses a data packet from an input data buffer of the module. In step 810, the module checks to determine if it is in a bypass mode of operation. If so, the data packet accessed in step 808 is retransmitted in step 812 without any modification of the data packet. If the module is not in bypass mode, then it must be in its active mode of operation and continues on to step 814. In step 814, the module reads the data packet to determine the identity of a source node from which the data packet originated. In step 816, it examines the packet to determine if the source node is valid. The specified source node can be compared to a list of valid nodes to determine if the specified source node is currently valid. If it is not a valid node then the packet is discarded in step 818. In step 820 the process checks to determine if a trigger event occurred. The occurrence of a trigger event will influence the selection of false identify values to use. Accordingly, in step 822, the module determines the false identify values to use based on one or more of the trigger information, clock time and mission plan. The module then continues to step 826 where it manipulates identity parameters of the data packet. Once manipulations are complete, the data packet is re-transmitted to an adjacent node from the output port of the module. In step 830, a determination is made as to whether the module has been commanded to power down. If so, the process ends at step 832. In step 808 the process continues and the next data packet is accessed from the module's input data buffer.

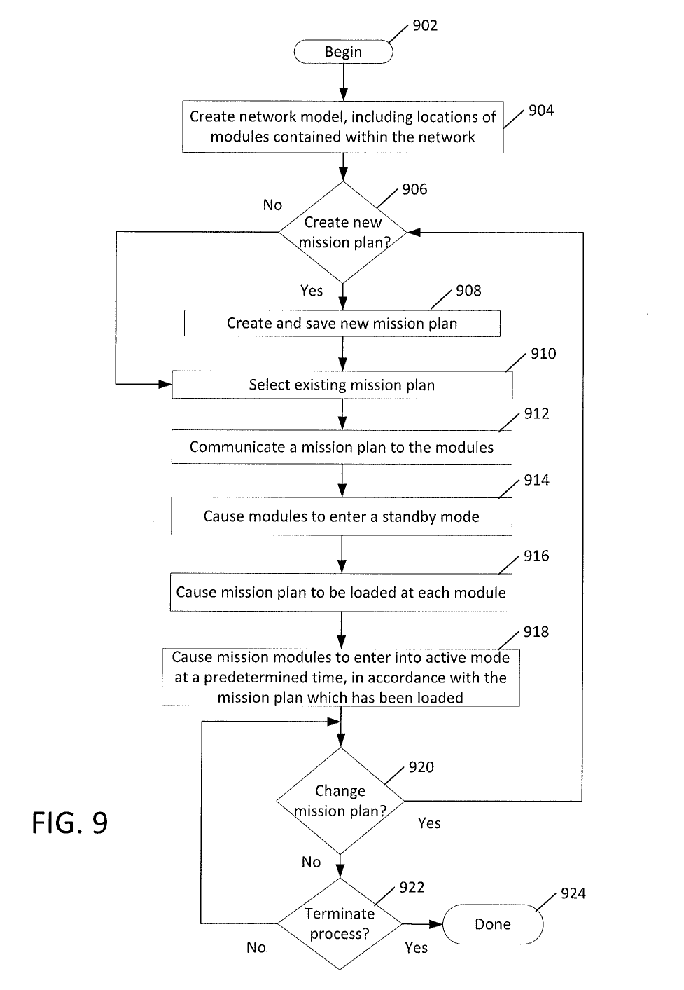

Referring now to FIG. 9, there is provided a flowchart which summarizes the methods described herein for managing a dynamic computer network. The process begins in step 902 and continues to step 904, where a network model is created (e.g. as shown and described in relation to FIG. 3). In step 906, a determination is made as to whether a new mission plan is to be created. If so, a new mission plan is created in step 908 and the process continues to step 910, where the new mission plan is selected. Alternatively, if in step 906 a desired mission plan has already been created, then the method can continue directly to step 910 where an existing mission plan is selected. In step 912, the mission plan is communicated to the modules (e.g. modules 105-107, 113, 114), where the mission plan is stored in a memory location. When the network administrator is ready to implement the new mission model, a command is sent in step 914 which causes the modules to enter a standby mode as described herein. While the modules are in this standby mode, the mission plan is loaded at step 916. Loading of the mission plan occurs at each module so that the mission plan can be used to control the operations of an application software executing on the module. In particular, the mission plan is used to control the way in which the application software performs dynamic manipulations of identity parameters. In step 918, the mission modules are again caused to enter into an active operational mode in which each mission module performs manipulations of identity parameters in accordance with the mission plan. Steps 914, 916, and 918 can occur in response to specific commands sent from a network administrator, or can occur automatically at each module in response to receiving the mission plan in step 912. After step 918, the modules continue performing processing in accordance with the mission plan which has been loaded. In step 920, the process continues by checking to determine if the user has indicated a desired to change the mission plan; if so, the process returns to step 906, where the it continues as described above. If there is no indication that the user or network administrator wishes to change an existing mission plan, then the process determines in step 922 whether it has been instructed to terminate. If so, the process terminate in step 924. If no termination instruction is received, the process returns to step 920 and continues.

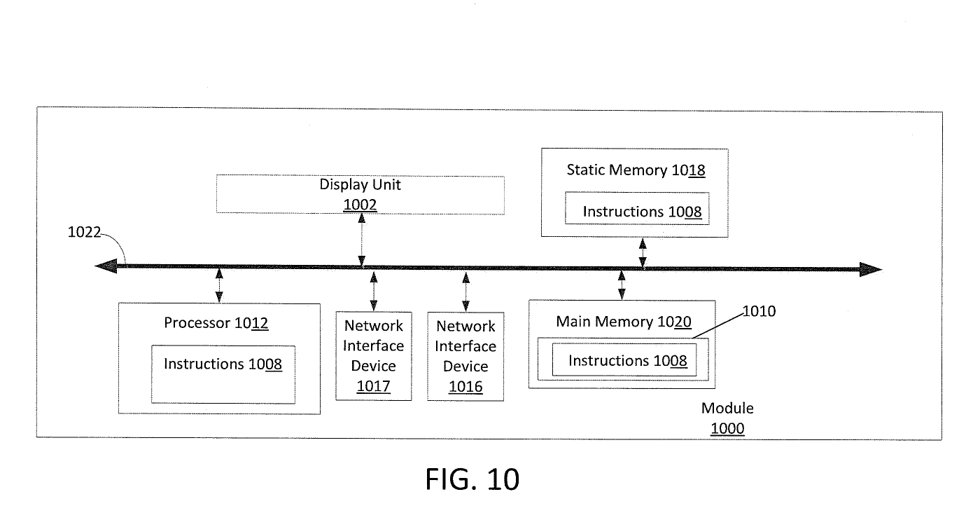

Referring now to FIG. 10, there is provided a block diagram which shows a computer architecture of an exemplary module 1000 which can be used for performing the manipulation of identity parameters described herein. The module 1000 includes a processor 1012 (such as a central processing unit (CPU), a main memory 1020 and a static memory 1018, which communicate with each other via a bus 1022. The computer system 1000 can further include a display unit 1002, such as a liquid crystal display or LCD to indicate the status of the module. The module 1000 can also include one or more network interface devices 1016, 1017 which allow the module to receive and transmit data concurrently on two separate data lines. The two network interface ports facilitate the arrangement shown in FIG. 1, where each module is configured to concurrently intercept and re-transmit data packets received from two separate computing devices on the network.

The main memory 1020 includes a computer-readable storage medium 1010 on which is stored one or more sets of instructions 1008 (e.g. software code) configured to implement one or more of the methodologies, procedures, or functions described herein. The instructions 1008 can also reside, completely or at least partially, within the static memory 1018, and/or within the processor 1012 during execution thereof by the module. The static memory 1018 and the processor 1012 also can constitute machine-readable media. In the various embodiments of the present invention a network interface device 1016 connected to a network environment communicates over the network using the instructions 1008.

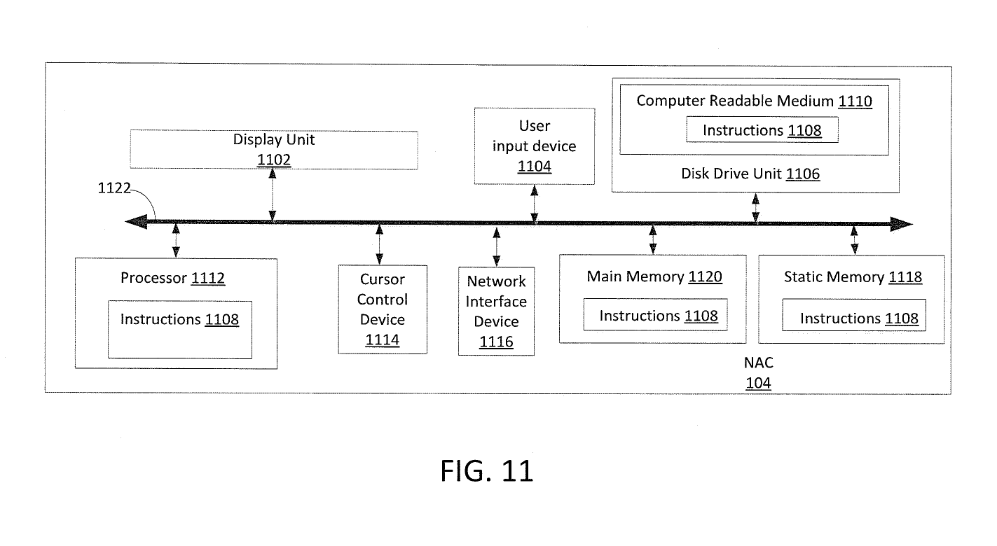

Referring now to FIG. 11, there is shown an exemplary network administration computer (NAC) 114 in accordance with the inventive arrangements. The NAC can comprise various types of computing systems and devices, including a server computer, a client user computer, a personal computer (PC), a tablet PC, a laptop computer, a desktop computer, a control system or any other device capable of executing a set of instructions (sequential or otherwise) that specifies actions to be taken by that device. Further, while a single computer is illustrated in FIG. 11, the phrase “NAC” shall be understood to include any collection of computing devices that individually or jointly execute a set (or multiple sets) of instructions to perform any one or more of the methodologies discussed herein.

Referring now to FIG. 11, the NAC 104 includes a processor 1112 (such as a central processing unit (CPU), a disk drive unit 1106, a main memory 1120 and a static memory 1118, which communicate with each other via a bus 1122. The NAC 104 can further include a display unit 1102, such as a video display (e.g. a liquid crystal display or LCD), a flat panel, a solid state display, or a cathode ray tube (CRT)). The NAC 104 can include a user input device 1104 (e.g. a keyboard), a cursor control device 1114 (e.g. a mouse) and a network interface device 1116.

The disk drive unit 1106 includes a computer-readable storage medium 1110 on which is stored one or more sets of instructions 1108 (e.g. software code) configured to implement one or more of the methodologies, procedures, or functions described herein. The instructions 1108 can also reside, completely or at least partially, within the main memory 1120, the static memory 1118, and/or within the processor 1112 during execution thereof. The main memory 1120 and the processor 1112 also can constitute machine-readable media.

Those skilled in the art will appreciate that the module architecture illustrated in FIG. 10, and the NAC architecture in FIG. 11, each represent merely one possible example of a computing device that can be used respectively for performing the methods described herein. However, the invention is not limited in this regard and any other suitable computing device architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments may implement functions in two or more specific interconnected hardware devices with related control and data signals communicated between and through the modules, or as portions of an application-specific integrated circuit. Thus, the exemplary system is applicable to software, firmware, and hardware implementations.

In accordance with various embodiments of the present invention, the methods described herein are stored as software programs in a computer-readable storage medium and are configured for running on a computer processor. Furthermore, software implementations can include, but are not limited to, distributed processing, component/object distributed processing, parallel processing, virtual machine processing, which can also be constructed to implement the methods described herein.

While the computer-readable storage medium 1010, 1110 is shown in FIGS. 10 and 11 to be a single storage medium, the term “computer-readable storage medium” should be taken to include a single medium or multiple media (e.g. a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but is not be limited to, solid-state memories such as a memory card or other package that houses one or more read-only (non-volatile) memories, random access memories, or other re-writable (volatile) memories; magneto-optical or optical mediums such as a disk or tape. Accordingly, the disclosure is considered to include any one or more of a computer-readable medium as listed herein and to include recognized equivalents and successor media, in which the software implementations herein are stored.

### Filtering Communications in a Dynamic Network

Before describing further aspects of the inventive arrangements, it is useful to consider the operation of a conventional firewall. Firewalls are specialized network components that filter communications at a boundary of a network. Communications are filtered in conventional firewalls based on a set of filtering rules. There are three primary categories of firewalls: packet or network layer firewalls, stateful firewalls, and application layer firewalls. All three of these categories can contain user-defined filtering rules to augment the native functionality of the firewall. Additionally, some types of application layer firewalls can apply heuristics based filtering rules to identify and terminate potentially malicious connections.

Packet firewalls operate by inspecting the contents of a data packet and comparing the contents to a set of filtering rules. Based on whether the packet matches one of the filtering rules, the firewall determines whether to allow the packet into the network. Packet firewalls operate up to the network layer of a protocol stack.

Stateful firewalls can keep track of the state of network connections by storing attributes of the connection in memory. Once an allowed connection has been set up within the firewall, packets from the allowed connection can be recognized by the firewall and allowed to enter the network. Packets that are not recognized as part of a known, active connection will be rejected. Stateful firewalls operate up to the transport layer of the protocol stack and are therefore capable of performing the functions of packet firewalls.

Application firewalls accomplish a similar task but are capable of filtering communications on the application or process level. Therefore, an application firewall is capable of distinguishing between allowed and disallowed traffic at the application level. As their name suggests, application firewalls can operate through all layers of a protocol stack, up to and including the application layer. Therefore, application firewalls include the functionality of packet and stateful firewalls discussed above.

In addition, application layer firewalls can engage in deep packet inspection techniques that enable inspection of the data payload of a packet, in addition to its header information. Heuristics based filtering combine the functionality of the above described firewalls with intrusion detection systems that are capable of analyzing network traffic to identify heuristics and patterns of common computer attacks. Heuristics based firewalls operate by identifying predefined signatures or patterns in data traffic that match common attacks, statistical anomalies that fall outside some predefined set of baseline parameters, and/or deviations of protocol states that fall outside a generalized profile of normal network activity.

User-defined filtering rules are defined by the user, typically a network administrator. User defined filtering rules can be as simple as allowing or denying all traffic from a particular port, using a particular protocol, from a particular source address, or any combination of traffic attributes. User-defined filtering rules can also be complex with interrelated sets of rules based on a network security policy. They can be applied to any of the three categories of firewalls described above.

A Moving Target Technology (MTT) firewall is able to perform firewall functions in accordance with one or more of the three categories of firewalls described above, but within an MTT enabled network operating in accordance with a mission plan. In addition to performing the native functions of conventional firewalls on conventional data traffic, an MTT firewall is also capable of performing the functions of a firewall on MTT enabled data traffic. To accomplish this, the MTT firewall is able to identify MTT enabled traffic based on the mission plan and perform filtering functions on the identified MTT enabled traffic. These filtering functions can include filtering rules similar to those used in conventional firewalls, but operable on MTT-enabled traffic. Alternatively or additionally, these filtering functions can include MTT filtering rules specifically designed for filtering MTT-enabled traffic.

A first aspect of an MTT enabled firewall is the ability to operate according to a mission plan and identify MTT enabled traffic based on that mission plan. To effectively filter incoming traffic into an MTT enabled network, it is advantageous for the firewall to be capable of identifying at least three types of data traffic: MTT traffic, static normal (benign) traffic, and attack traffic. Normal traffic and attack traffic can be filtered using existing firewall technology. However, current technology is unable to process MTT enabled traffic. An example of MTT traffic entering a firewall is a data packet sent through the internet from one secure enclave operating a first MTT enabled network to another enclave operating a second MTT enabled network. In such a scenario, the firewall at each enclave is advantageously capable of identifying and distinguishing MTT traffic from static traffic.

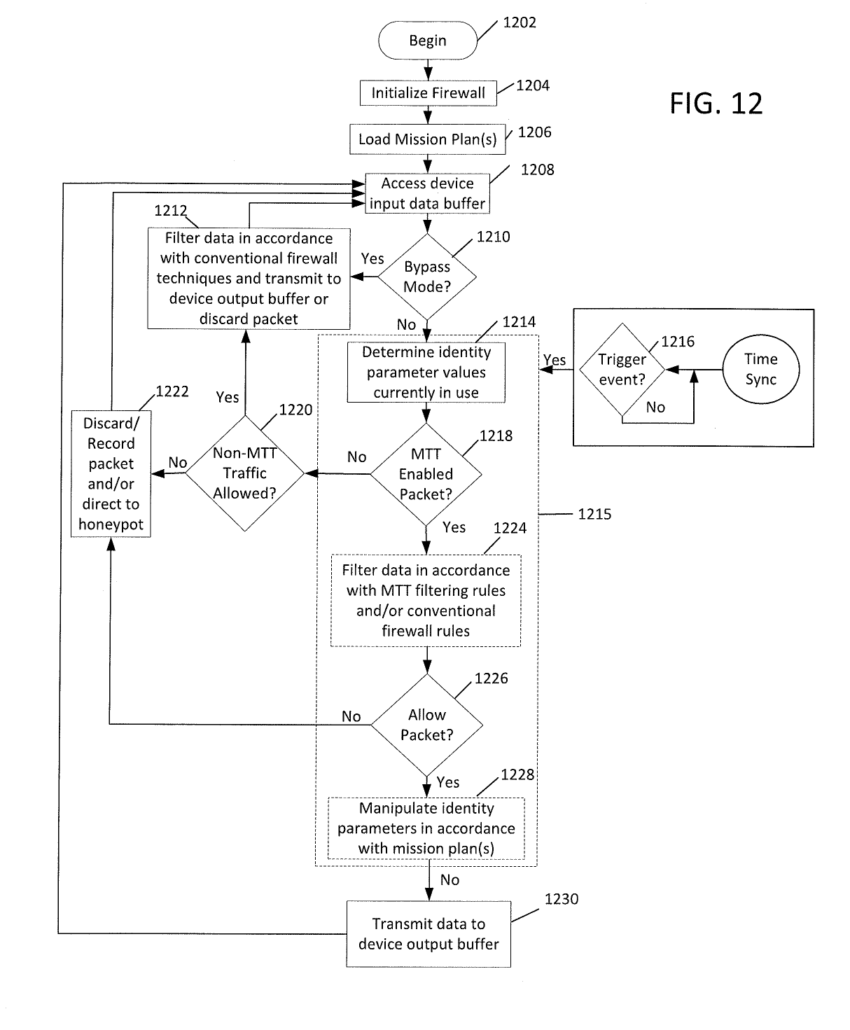

Referring now to FIG. 12, a flowchart is provided describing a method embodiment of an MTT enabled firewall. The process begins at step 1202 when the firewall is powered up and continues to step 1204 where firewall application software is initialized for executing the methods described herein. In step 1206, one or more mission plans are loaded from a memory location within the firewall. A mission plan can define a dynamic maneuvering of one or more logical networks within a single dynamic computer network. One or more mission plans can be loaded in a firewall in a manner similar to that described above in relation to modules. For example a first mission plan can define a dynamic maneuvering of a first MTT enabled network in a first enclave, and a second mission plan can define a dynamic maneuvering of a second MTT enabled network in a second enclave. In the exemplary embodiments described herein, the first MTT enabled network is a source MTT network from which a packet has originated, and the second MTT enabled network is a destination MTT network to which the packet has been sent. The mission plans for each network can be loaded into a memory associated with the firewall. In a preferred embodiment, the mission plans are loaded into the memory associated with the firewall and are activated. The state of each mission plan will generally be determined based on one or more trigger events. The trigger event is any predetermined type of stimulus which causes an operation of the mission plan to dynamically change the way that identity parameters are being manipulated in the network. As such, the occurrence of a trigger event effectively results in an MTT device (e.g. the firewall) that is able to distinguish between traffic received before the trigger event, which is processed using previously active rules, and traffic received after the trigger event, which is processed using the newly activated rules. As noted above, the trigger event can result from a variety of different conditions and input stimuli applied to the network. In some embodiments, the mission plans stored for use by the firewall may be loaded into memory when the firewall is not active, or during a time when the MTT operations of the network are disabled, e.g. when the firewall is in a by-pass state.

Once the mission plans have been loaded, the firewall is ready to begin processing data and proceeds to do so at step 1208, where it accesses a data packet from an input data buffer of the firewall. The input data buffer will contain data packets received at the firewall from the source MTT network. For example, the packets can be received at the firewall via the internet. One of skill in the art will recognize that the firewall device may also include the functionality of a bridge, router, or module. Alternatively, a bridge, router, or module can also include firewalling functionality. The embodiments of the present invention are not limited in this regard.

In step 1210, the firewall checks to determine if the MTT mode of operation has been disabled. More particularly, the firewall checks to determine whether a current mode of operation is a bypass mode. If bypass mode is enabled (1210: Yes), the data packet accessed in step 1208 is filtered in accordance with conventional firewall techniques. Conventional firewall filtering rules are applied to the data and, based on such filtering, the data is either transmitted to an output buffer of the firewall or discarded in step 1212. Step 1212 can involve the use of a set of conventional filtering rules which are suitable for packets that contain true identity parameter values. In other words, this mode is used when the MTT mode of operation is not active and all identity parameters are assumed to have their true values. In such circumstances, the firewall either decides to allow the packet and communicates it to the appropriate output port, or rejects the packet and discards it according to a set of filtering rules. Accordingly, when in the bypass mode, the firewall functions in substantially the same way that a conventional firewall would.

If the bypass mode is not enabled (1210: No), this will serve as an indication that MTT data is expected, and the process continues on to step 1214. In step 1214, the firewall determines identity parameter values (including false identity parameter values) which are currently in use by the source MTT network. This step can be performed in a variety of different ways. In some embodiments, this can be accomplished by accessing a mission plan associated with the source MTT network, and performing pseudorandom processing to calculate a complete set of all false identity parameter values currently in use within the source network. This step can involve determining the set of currently allowed false identity parameters by performing a pseudorandom transformation on a set of currently valid true identity parameters using a seed value and a pseudorandom transform algorithm specified in the mission plan. The false identity parameter values thus calculated can then be stored in a table for use in subsequent processing steps. This step can also involve populating a table that relates each true identity parameter value with a currently allowed false identity parameter.

Alternatively, step 1214 can involve a more limited determination which involves only calculating a partial set of false identity parameter values. For example, such partial set could be limited to a selected group of identity parameters. Use of such partial sets can limit the ability of the firewall for purposes of evaluating all of the identity parameter values contained in a datagram. However, calculation of a partial set of false identity parameters is less processing intensive and could be advantageous in certain scenarios, particularly when identity parameter values are being changed at a rapid rate.

In step 1216, the firewall checks to determine if a trigger event has occurred that would change the MTT status. This step of checking for the occurrence of a trigger event can be performed periodically as shown based on a clock signal, or it can be performed at any time during the process included within box 1215. This is an important step because the occurrence of a trigger event can have a significant effect upon the calculation of proper false identify parameter values that are currently in use in the source MTT network. The information from step 1216, and any other appropriate information concerning the MTT status of the source MTT network, is then used to update the current status of any MTT manipulations that are in use by the source MTT network at that time, and to perform any necessary modifications to the firewall rules applied to incoming packets. For example, in step 1214 the occurrence of a trigger event can cause the system to generate an updated set of filtering rules based on a new set of false value identity parameters based on the mission plan. These new filtering rules allow the firewall to properly identify and filter data packets received after the trigger event occurs.

In step 1218, the firewall determines whether the packet is an MTT enabled packet. In this step, the identity parameters of the data packet are analyzed and compared to those that are expected for MTT traffic. In its simplest form, this can involve merely determining whether each of the identity parameters contained in a packet correspond to a set of false identity parameters that are currently in use as specified by a mission plan for the source network. For example this can be accomplished by comparing false identity parameters in a received datagram to determine if they are contained in the table that is generated in step 1214. However, more sophisticated levels of analysis are also possible. For example, the firewall can evaluate two or more of the false identity parameters contained in a packet to determine whether they properly being used together to identify a particular source and/or destination node of the network. Additionally, since the false identity parameters are governed by the mission plan, the firewall is capable of identifying or calculating the “movement” of the identity parameters, i.e. what the false identity parameters were in a previous time epoch, what they are in the current time epoch, and/or what they will be in the next time epoch. Still, the invention is not limited in this regard and other evaluation schemes are also possible. This calculation of past and future values of false identity parameters can be useful for purposes of providing windows of time for accommodating system delays and timing variations as between the source and destination network.

Once the data packet is identified as an MTT data packet (1218: Yes), the firewall can allow the traffic to enter into the destination network simply on that basis. If it is determined in step 1218 that the data packet is not associated with an MTT enabled network (1218: No), then the firewall proceeds to step 1220 where it determines whether non-MTT traffic is allowed by the mission plan. If not (1220: No), then the firewall discards the packet in step 1222 and returns to step 1208 to access the next packet in the firewall's input buffer. If non-MTT traffic is allowed (1220: Yes) the firewall proceeds to step 1212 where it applies conventional filtering/heuristics analysis to the packet and either allows or discards the packet based on a set of filtering rules.

As described above, simply identifying a packet as being MTT enabled in step 1220 may be sufficient to allow the packet to enter the network in step 1226. Optionally, the firewall can proceed to step 1224 where it can further apply a set of MTT filtering rules which have been specifically defined for MTT traffic. In some embodiments such MTT filtering rules can be similar to the rules applied to conventional filtering operations performed in step 1212. Of course, if such conventional filtering rules are applied, suitable adjustments must be made to accommodate the false identity parameter values in the MTT enabled packet. This can involve dynamic modification of the filtering rules and/or transformation of the false identity parameter values to true identity parameter values, for purposes of applying the filtering rules. Alternatively, filtering rules applied to MTT enabled data can be different from conventional firewall rules.

If the MTT data packet satisfies the requirements of the MTT filtering rules in step 1224, then the packet is allowed entry into the network in step 1226. If the MTT data packet does not satisfy the requirements of the MTT filtering rules, the packet is not allowed into the network in step 1226. Alternatively, the filtering rules can be designed such that packets that do not satisfy the requirements of a particular a rule are allowed and those that do satisfy the requirements of a particular rule are disallowed. In either case, a disallowed packet can be discarded in step 1222. In another embodiment, the firewall can include or be in communication with a “honeypot” server that can mimic the behavior of network systems to lure attack traffic. As used herein a honeypot server is one that is specifically configured to mislead a network attacker. In this embodiment, the filtering rules can be designed so that the firewall, in step 1222, directs disallowed packets to the honeypot instead of discarding them outright. By filtering disallowed packets to the honeypot, especially those associated with attack traffic, a network administrator can not only prevent a successful attack, but also can analyze network vulnerabilities and/or develop new techniques for countering attacks based on the behavior of the disallowed traffic. In another embodiment, the packet is recorded or logged prior to being discarded or directed to the honeypot. After the disallowed traffic is processed in step 1222, the firewall returns to step 1208 to access the next packet in the firewall's input buffer.

In addition to performing the filtering functions described herein, the firewall can be configured to perform dynamic manipulations of identity parameters in a manner similar to that described above with respect to the modules. Referring again to FIG. 12, optional step 1228 can comprise dynamic manipulation of identity parameters in accordance with a mission plan and a current network status of the destination MTT network. The operations at step 1228 would be similar to identity parameter manipulations performed by modules 105-107, 113, 114 as described above. The firewall can modify the group of identity parameters for which false values are to be assigned. The firewall can also manipulate one or more false identity parameter values to specify false values that are different from those assigned by the source MTT network. In a preferred embodiment, the set of false identity parameters and the actual false values would be determined in accordance with a mission plan for the destination MTT network. Notably, the manipulation operations in step 1228 can be selectively toggled on and off in accordance with a mission plan. This bypass mode of operation can be implemented in steps 1210 and 1212 as described above. Alternatively, step 1228 can be bypassed individually.

Once all filtering processing in box 1215 is complete, and the packet is allowed entry into the network, the process continues to step 1230 where the packet is then transmitted to the device output buffer without additional processing. The firewall then returns to step 1208 to access the next packet from the input buffer.

For purposes of describing the invention thus far, it has been assumed that the packets received from the source network are manipulated in accordance with the mission plan associated with the source network. However, it can be advantageous in some embodiments for the source network to manipulate identity parameters in a datagram prior to their transmission to the destination network. Specifically, the identity parameters in the transmitted packet can be manipulated so that they are consistent with a current set of false identity parameters in use by the destination network. This would be accomplished at the source network by utilizing the mission plan for the destination network. If a received packet has been manipulated to contain false identity parameters consistent with the destination network, certain steps in FIG. 12 must be adjusted to accommodate this variation of the invention. For example, in step 1214, the false identity parameter values which are determined will be those that are in use within the destination network. Similarly, step 1214 will involve an evaluation of whether the datagram includes false identity parameters that correctly correspond with those false identity parameters currently in use within the destination network. Also, steps 1228 and 1230 will generally be unnecessary in such a scenario since the received packet will already contain false identity parameters that are consistent with those in use in the destination network.

It should further be noted that the invention is not limited to the particular methods described herein for evaluating the false identity parameters in a received datagram. Other methods are also possible and all such methods are intended to be included within the scope of the invention. For example, rather than attempting to generate a table containing all false identity parameters that are currently in use in step 1214, a different approach could be used. In such an embodiment, the firewall at the destination node could apply an inverse of an algorithm used at the source node to directly compute a set of “true” identity parameter values based on the false identity parameter values contained in a datagram. This would involve reading a timestamp associated with the data packet and performing an inverse pseudorandom transformation using the seed value and said timestamp to determine a true identity parameter that corresponds with at least one of said identity parameters of said packet. This set of “true” identity parameter values could then be evaluated to determine if they are in fact within allowed ranges for identity parameters properly associated with the source network and/or destination network. A similar approach could of course be used in those instances where the false identity parameters have been manipulated at the source network to contain false identity parameter values that correspond to those currently in use by destination network as specified in a mission plan.

To further understand the operation of the MTT firewalls described herein, consider the example of an application layer firewall in which an FTP session has been established. After the FTP session is set up as an active connection, the attributes of that connection can change in accordance with an MTT session defined by a mission plan. For example, the source IP address of the session may be transformed in response to a trigger event, in accordance with a particular mission plan. As discussed above, the trigger can be based on a chronological event, such as a clock time, or an expiration of some pre-determined period of time. Alternatively, the trigger can be based on a user input or the detection of a network threat. The firewall can receive notifications concerning such trigger events from a network operation center. Such communications can be in-band (using the network) or by using some out-of-band communication method external to the network. After the trigger event occurs, new packets for the same session arriving at the firewall will appear as though they are sent from a different source address, heading to a different destination address, and/or arriving at a different port than was used when the session was started. The new packets are still from the same original source host and are being sent to the same original destination host. However, the identity parameters of the packets from that host “move” in accordance with the mission plan. A conventional firewall would not be able to handle these new packets because they are outside the scope of the original session, as defined by the connection state. An MTT enabled firewall, operating in accordance with the same mission plan as the source network of the packet, will be able to recognize the movement of the new packets as part of the same session previously established with different identity parameters. In other words, the MTT firewall is configured to allow movement of the identity parameters in accordance with the mission plan and in response to any of the various trigger events that can occur while a connection is in an active state. Accordingly, the MTT firewall identifies the new packets with the established FTP session and allows the packets to enter the network. Similar functions can be accomplished with stateful firewall rules and in traffic heuristics and analysis of MTT traffic.

Types of Identity Parameters that can be Varied

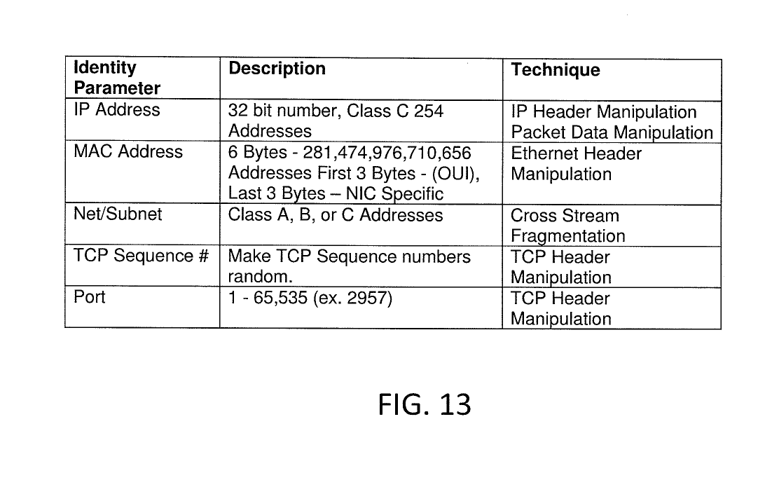

Referring now to FIG. 13, there is provided a list of some of the identity parameters that can be manipulated by the modules 105-107, 113, 114, bridge 115 and/or by router 110. Each of the parameters listed in FIG. 13 is included in a data communication included in a network using a TCP/IP communication protocol. Most of the information types listed in FIG. 13 are well known to those skilled in the art. However, a brief description of each type of information and its use as an identity parameter is provided herein. Also provided is a brief discussion of the ways in which each identity parameter can be manipulated.

IP Address. An IP Address is a numerical identifier assigned to each computing device participating in a computer network where the network uses the well known Internet Protocol for communication. The IP address can be a 32 bit or 128 bit number. For purposes of the present invention, the IP address number can be changed to a false value that is selected randomly (e.g. using a pseudorandom number generator). Alternatively, the false IP address value can be randomly selected from a predetermined list of false values (e.g. a list specified by a mission plan). The source and destination IP addresses are included in header portion of a data packet. Accordingly, manipulation of these values is performed by simply changing by using packet manipulation techniques which change the IP header information. When the packet arrives at a second module (the location of which can be manipulated), the false IP address values are transformed back to their true values. The second module uses the same pseudorandom process (or its inverse) to derive the true IP address value based on the false value.

MAC Address. A MAC address is a unique value assigned to a network interface device by a manufacturer and stored in an onboard ROM. For purposes of the present invention, the source and/or destination MAC address can be changed to a false value that is selected randomly (e.g. using a pseudorandom number generator). Alternatively, the false MAC value can be randomly selected from a predetermined list of false values (e.g. a list specified by a mission plan). The source and destination MAC addresses are included in header portion of data packet. Accordingly, manipulation of these values is performed by simply changing an Ethernet header information of each packet. When the packet arrives at a second module (the location of which can be manipulated), the false MAC address values are transformed back to their true values. A module receiving a packet will use the same pseudorandom process (or its inverse) to derive the true MAC address value based on the false value.

Network/Subnet. In some embodiments, the IP address can be thought of as a single identity parameter. However, an IP address is generally defined as including at least two parts which include a network prefix portion and a host number portion. The network prefix portion identifies a network to which a data packet is to be communicated. The host number identifies the particular node within a Local Area Network (LAN). A sub-network (sometimes referred to as a subnet) is a logical portion of an IP network. Where a network is divided into two or more sub-networks, a portion of the host number section of the IP address is used to specify a subnet number. For purposes of the present invention, the network prefix, the subnet number and the host number can each be considered to be a separate identity parameter. Accordingly, each of these identity parameters can be separately manipulated independently of the others in a pseudorandom way. Moreover, it will be appreciated that a data packet will include a source IP address and a destination IP address. Accordingly, the network prefix, the subnet number and host number can be manipulated in the source IP address and/or the destination IP address, for a total of six different variable identity parameters that can be manipulated in a pseudorandom way. A module receiving a packet will use the same pseudorandom process as an originating node (or the inverse of such process) to derive the true Network/subnet information value based on the false value.

TCP Sequence. Two client computers communicating with each other on opposite sides of a TCP session will each maintain a TCP sequence number. The sequence number allows each computer to track how much data it has communicated. The TCP sequence number is included in the TCP header portion of each packet which is communicated during the session. At the initiation of a TCP session, the initial sequence number value is randomly selected. For purposes of the present invention, the TCP sequence number can be manipulated as an identity parameter in accordance with a pseudorandom process. For example, the TCP sequence number can be changed to a false value that is selected randomly (e.g. using a pseudorandom number generator). When the packet is received at a different module of the network (the location of which will be dynamically varied), the TCP sequence number can be transformed from a false value back to a true value, using an inverse of the pseudorandom process.

Port Number. A TCP/IP port number is included in the TCP or UDP header portion of a data packet. Ports as used in the TCP/IP communication protocol are well known in the art and therefore will not be described herein in detail. The port information is contained within the TCP header portion of the data packet. Accordingly, manipulation of the port information is accomplished by simply modifying the TCP header information to change a true port value to a false port value. As with the other identity parameters discussed here, the port number information can be manipulated or transformed to a false value in accordance with a pseudorandom process at a first module. The port information can later be transformed from a false value to a true value at a second module, using an inverse of the pseudorandom process.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

We claim:

1. A method of filtering data communications in a dynamic computer network, the method comprising:
receiving a data packet that includes a plurality of identity parameters; and
filtering said data packet by comparing said plurality of identity parameters to a set of filtering rules, wherein said filtering rules comprise allowing said data packet on a condition that a first set of said identity parameters have been pseudorandomly transformed to specify false identity parameters that are within a set of currently allowed false identity parameters determined based on a mission plan.

2. The method of claim 1, wherein said filtering rules further comprise on a condition that at least one of said first set of identity parameters that specify false identity parameters are not within said set of currently allowed false identity parameters, discarding said packet.

3. The method of claim 1, wherein said filtering rules further comprise on a condition that at least one of said set of false identity parameters are not within said set of currently allowed false identity parameters, directing said packet to a server specifically configured to mislead a network attacker.

4. The method of claim 1, further comprising:
determining said set of currently allowed false identity parameters by performing a pseudorandom transformation on a set of currently valid true identity parameters using a seed value and a pseudorandom transform algorithm specified in said mission plan.

5. The method of claim 4, further comprising:
populating a table that relates each true identity parameter of said set of currently valid true identity parameters with a false identity parameter of said set of currently allowed false identity parameters.

6. The method of claim 4, wherein the pseudorandom transformation is performed as each data packet is received, the method further comprising:
reading a timestamp associated with said data packet; and
performing said pseudorandom transformation using said seed value and said timestamp to determine a true identity parameter that corresponds with at least one of said identity parameters of said packet.

7. The method of claim 4, wherein at least one element of said pseudorandom transformation is varied in response to a trigger event specified in said mission plan and based on at least one of a user command, a timing interval, and a detection of a potential network security threat.

8. The method of claim 7, further comprising:
transforming a second set of said plurality of identity parameters of said data packet in response to said trigger event and based on said mission plan.

9. The method of claim 1, further comprising applying at least one filtering rule to said data packet exclusive of testing for the occurrence of said currently allowed false identity parameters.

10. The method of claim 9, wherein said plurality of identity parameters all specify true information.

11. A network device comprising:
input circuitry connected to at least one input port configured to receive a data packet that includes a plurality of identity parameters;
a computer-readable storage medium, having stored thereon a computer program for filtering data communications in a dynamic network, the computer program having a plurality of code sections, the code sections executable by a network device to cause the network device to perform the steps of:
filtering said data packet by comparing said plurality of identity parameters to a set of filtering rules, wherein said filtering rules comprise allowing said data packet on a condition that a first set of said identity parameters have been pseudorandomly transformed to specify false identity parameters that are within a set of currently allowed false identity parameters determined based on a mission plan.

12. The network device of claim 11, wherein said filtering rules further comprise discarding said packet on a condition that at least one of said first set of identity parameters that specify false identity parameters are not within said set of currently allowed false identity parameters.

13. The network device of claim 11, wherein said filtering rules further comprise directing said packet to a honeypot server on a condition that at least one of said set of false identity parameters are not within said set of currently allowed false identity parameters, said honeypot server specifically configured to mislead a network attacker.

14. The network device of claim 11, further comprising coded sections causing said network device to perform the step of:
determining said set of currently allowed false identity parameters by performing a pseudorandom transformation on a set of currently valid true identity parameters using a seed value and a pseudorandom transform algorithm specified in said mission plan.

15. The network device of claim 14, wherein the pseudorandom transformation is performed prior to receiving data, the network device further comprising coded sections causing said network device to perform the step of:
populating a table that relates each true identity parameter of said set of currently valid true identity parameters with a false identity parameter of said set of currently allowed false identity parameters.

16. The network device of claim 14, wherein the pseudorandom transformation is performed as each data packet is received, the network device further comprising coded sections causing said network device to perform the step of:
reading a timestamp associated with said data packet; and
performing said pseudorandom transformation using said seed value and said timestamp to determine a true identity parameter that corresponds with at least one of said identity parameters of said packet.

17. The network device of claim 14, configured to selectively modify at least one element of said pseudorandom transformation in response to a trigger event specified in said mission plan and based on at least one of a user command, a timing interval, and a detection of a potential network security threat.

18. The network device of claim 17, comprising coded sections causing said network device to perform the step of:
transforming a second set of said plurality of identity parameters of said data packet in response to said trigger event and based on said mission plan.

19. The network device of claim 11, wherein said plurality of filtering rules further comprise testing said data packet for the occurrence of a condition exclusive of said currently allowed false identity parameters.

20. The network device of claim 11, where said network device is one of a router, a bridge, a switch, and a gateway.
